(19) United States
(12) Patent Application Publication
(10) Pub. No.: US 2025/0153201 A1
(43) Pub. Date: May 15, 2025

(54) WATER OUTLET DEVICE AND WATER OUTLET SYSTEM

(71) Applicant: FUJIAN XIHE SANITARY WARE TECHNOLOGY CO., LTD, Fujian (CN)

(72) Inventors: Xiaofa LIN, Fujian (CN); Xiaoshan LIN, Fujian (CN); Xiaocong LIN, Fujian (CN); Jianhui GAO, Fujian (CN); Xiaoqing DENG, Fujian (CN); Qiqiao LIU, Fujian (CN)

(73) Assignee: FUJIAN XIHE SANITARY WARE TECHNOLOGY CO., LTD, Fujian (CN)

(21) Appl. No.: 18/522,618

(22) Filed: Nov. 29, 2023

(30) Foreign Application Priority Data
Nov. 15, 2023 (CN) 202323087093.X

(51) Int. Cl. B05B 1/18; B05B 1/16

(52) U.S. Cl. CPC B05B 1/185; B05B 1/16

(57) ABSTRACT

A water outlet device and a water outlet system are disclosed. The water outlet device includes a body mechanism provided with a water separating end face and a water outlet end face, a first sealing member provided on the water separating end face, a switching member movably installed on the body mechanism and fit to a side of the first sealing member away from the water separating end face, a supporting member supported between the body mechanism and a side of the switching member away from the first sealing member, and a pushing mechanism movably installed on the body mechanism. The water outlet end face is provided with a plurality of water outlet areas. A water outlet flow channel is penetrated between each water outlet area and the water separating end face. The pushing mechanism drives the switching member to move with respect to the body mechanism.

### CROSS-REFERENCE TO RELATED APPLICATION

This application claims foreign priority benefits under 35 U.S.C. § 119(a)-(d) to Chinese patent application number 202323087093.X, filed Nov. 15, 2023, which is hereby incorporated by reference herein in its entirety.

### TECHNICAL FIELD

The present application relates to, but is not limited to, kitchen and bathroom technologies, in particular to a water outlet device and a water outlet system.

### BACKGROUND

Existing water outlet device is generally provided with a switching member, and by driving it to move, a water inlet flow channel may be in communication with different water outlet flow channels, thereby realizing water outlet through different water outlet areas. In order to ensure isolation between different water outlet flow channels and realize water outlet effects through different water outlet areas, a sealing structure is generally provided between the switching member and the water outlet flow channels, and sealing performance between the switching member and the water outlet flow channels is further improved under a driving action of water pressure on the switching member. However, when a water pressure is low, sealing failure between the switching member and the water outlet flow channels is easy to occur, resulting in series leakage.

### SUMMARY

The present application provides a water outlet device and a water outlet system, aiming at solving the technical problem that the existing water outlet device with a function of switching the water outlet through water outlet areas is easy to produce series leakage when the water pressure is low.

To achieve the above objects, the present application provides a water outlet device including:
a body mechanism provided with a water separating end face and a water outlet end face, the water outlet end face being provided with a plurality of water outlet areas, wherein the body mechanism is provided with a water inlet flow channel and a plurality of water outlet flow channels, and each of the plurality of water outlet flow channels is one-to-one corresponding to each of the plurality of water outlet areas and penetrates between the corresponding water outlet area and the water separating end face;
a first sealing member provided on the water separating end face and provided with a plurality of flow holes, each of the plurality of flow holes being one-to-one corresponding to and communicating with each of the plurality of water outlet flow channels;
a switching member movably installed on the body mechanism and fitted against a side of the first sealing member away from the water separating end face, wherein the switching member is provided with a through hole;
a supporting member supported between the body mechanism and a side of the switching member away from the first sealing member and movably connected with at least one of the body mechanism and the switching member; and
a pushing mechanism movably installed on the body mechanism, wherein the pushing mechanism is configured to be capable of driving the switching member to move with respect to the body mechanism so that the through hole communicates one of the plurality of flow holes with the water inlet flow channel, or the plurality of flow holes disconnect from the water inlet flow channel.

To achieve the above objects, the present application further provides a water outlet system including the water outlet device as described above.

The implementation of embodiments of the present application will have the following beneficial effects.

When the water outlet device of the above scheme is used and installed in a water outlet system, it not only makes the water outlet system have excellent cleaning efficiency, but also can ensure the sealing between the switching member and the water outlet flow channel and avoid the occurrence of series leakage. Specifically, the water outlet device includes a body mechanism provided with a water separating end face and a water outlet end face, a first sealing member provided on the water separating end face, a switching member movably installed on the body mechanism and fitted against a side of the first sealing member away from the water separating end face, a supporting member supported between the body mechanism and a side of the switching member away from the first sealing member, and a pushing mechanism movably installed on the body mechanism. The water outlet end face is provided with a plurality of water outlet areas. A water outlet flow channel penetrates between each water outlet area and the water separating end face. The pushing mechanism drives the switching member to move with respect to the body mechanism, so that the communication state between the water inlet flow channel and the plurality of water outlet flow channels can be changed, and then switching different water outlet areas to discharge water can be achieved or the plurality of water outlet areas can be closed at the same time according to specific requirements in use. The provision of the supporting member can ensure that the switching member and the first sealing member are closely fit, so that a change of water pressure has little influence on the sealing performance between the switching member and the water outlet flow channels, thus avoiding the occurrence of series leakage when the water pressure is low.

Other features and advantages of the present application will be set forth in the description which follows, and in part will be obvious from the description, or may be learned by practice of the present application. Other advantages of the present application may be realized and attained by the solutions described in the description as well as the drawings.

### BRIEF DESCRIPTION OF THE DRAWINGS

Accompanying drawings are used to provide an understanding of the technical solutions of the present application, and constitute a part of the specification. Together with the embodiments of the present application, they are used to explain the technical solutions of the present application and do not constitute a limitation on the technical solutions of the present application.

FIG. 1 is a front view of a water outlet device according to an embodiment of the present application;

FIG. 2 is a schematic diagram of an exploded structure of the water outlet device shown in FIG. 1;

FIG. 3 is an enlarged schematic diagram of a structure of Part A in FIG. 2;

FIG. 4 is an enlarged schematic diagram of a structure of Part B in FIG. 2;

FIG. 5 is an enlarged schematic diagram of a structure of Part C in FIG. 2;

FIG. 6 is a sectional view of the water outlet device shown in FIG. 1;

FIG. 7 is an enlarged schematic diagram of a structure of Part D in FIG. 6;

FIG. 8 is an enlarged schematic diagram of a structure of Part E in FIG. 6;

FIG. 9 is a schematic assembly diagram of a water inlet member, a switching member, a rotating member and a push rod in the water outlet device shown in FIG. 1;

FIG. 10 is a schematic diagram of a position of a push button and a position of a rotating member when a water outlet device is in a state of discharging water from a central area according to an embodiment of the present application;

FIG. 11 is a schematic diagram of a water flow direction when a water outlet device is in a state of discharging water from a central area according to an embodiment of the present application;

FIG. 12 is an enlarged schematic diagram of a structure of Part F in FIG. 11;

FIG. 13 is an enlarged schematic diagram of a structure of Part G in FIG. 11;

FIG. 14 is an enlarged schematic diagram of a structure of Part H in FIG. 11;

FIG. 15 is a schematic diagram of a position of a push button and a position of a rotating member when a water outlet device is in a state of discharging water from an inner ring area according to an embodiment of the present application;

FIG. 16 is a schematic diagram of a water flow direction when a water outlet device is in a state of discharging water from an inner ring area according to an embodiment of the present application;

FIG. 17 is an enlarged schematic diagram of a structure of Part I in FIG. 16;

FIG. 18 is an enlarged schematic diagram of a structure of Part J in FIG. 16;

FIG. 19 is an enlarged schematic diagram of a structure of Part K in FIG. 16;

FIG. 20 is a schematic diagram of a position of a push button and a position of a rotating member when a water outlet device is in a state of discharging water from a middle ring area according to an embodiment of the present application;

FIG. 21 is a schematic diagram of a water flow direction when a water outlet device is in a state of discharging water from a middle ring area according to an embodiment of the present application;

FIG. 22 is an enlarged schematic diagram of a structure of Part L in FIG. 21;

FIG. 23 is an enlarged schematic diagram of a structure of Part M in FIG. 21;

FIG. 24 is an enlarged schematic diagram of a structure of Part N in FIG. 21;

FIG. 25 is a schematic diagram of a position of a push button and a position of a rotating member when a water outlet device is in a state of discharging water from an outer ring area according to an embodiment of the present application;

FIG. 26 is a schematic diagram of a water flow direction when a water outlet device is in a state of discharging water from an outer ring area according to an embodiment of the present application;

FIG. 27 is an enlarged schematic diagram of a structure of Part O in FIG. 26;

FIG. 28 is an enlarged schematic diagram of a structure of Part P in FIG. 26;

FIG. 29 is an enlarged schematic diagram of a structure of Part Q in FIG. 26;

FIG. 30 is a schematic diagram of a structure of a face cover of a water outlet device according to an embodiment of the present application;

FIG. 31 is a rear view of a water outlet device according to another embodiment of the present application with a back cover removed, in which a sectional view of a portion of a positioning assembly is shown; and

FIG. 32 is a schematic assembly diagram of a rotating member and a positioning member of a water outlet device according to another embodiment of the present application.

Reference signs are described as follows.

10: body mechanism; 11: face shell assembly; 111: water separating end face; 1111: annular wall; 1112: support structure; 112: water outlet end face; 113: face cover; 114: water dispensing disk; 115: water separating tray; 1121: water outlet area; 1121a: central area; 1121b: inner ring area; 1121c: middle ring area; 1121d: outer ring area; 12: water inlet assembly; 121: connecting member; 122: water inlet member; 123: connecting pipe; 13: decoration shell; 14: back cover; 15: second sealing member; 20: first sealing member; 30: switching member; 31: switching portion; 32: connecting portion; 321: first clamping member; 3211: elastic arm; 3212: limiting structure; 32121: guide surface; 40: supporting member; 50: pushing mechanism; 51: rotating member; 511: first transmission portion; 52: pushing assembly; 521: second transmission portion; 522: limiting portion; 523: push button; 5231: third plug portion; 524: push rod; 5241: first plug portion; 525: transmission member; 5251: second plug portion; 5252: fourth plug portion; 60: pulse assembly; 61: water ejecting ring; 62: impeller; 63: swing sheet; 64: pin shaft; 70: positioning assembly; 71: installing member; 72: elastic member; 80: positioning member; 81: positioning portion; 100: water inlet flow channel; 200: water outlet flow channel; 201a: first water outlet chamber; 201b: second water outlet chamber; 201c: third water outlet chamber; 201d: fourth water outlet chamber; 300: flow hole group; 301: flow hole; 301a: first flow hole; 301b: second flow hole; 301c: third flow hole; 301d: fourth flow hole; 400: through hole; 500: water inlet hole group; 501: water inlet hole; 501a: first water inlet hole; 501b: second water inlet hole; 501c: third water inlet hole; 501d: fourth water inlet hole; 600: water outlet hole; 700: water inlet chamber; 800: chute; 900: clamping slot; 1000: installation slot.

The realization of the objects, functional features and advantages of the present application are further explained with reference to the accompanying drawings in connection with the embodiments.

### DETAILED DESCRIPTION

The present application describes multiple embodiments, but the description is exemplary rather than restrictive, and it will be obvious to those of ordinary skills in the art that more embodiments and implementations may be included within the scope of the embodiments described by the present application. Although many possible combinations of features are shown in the drawings and discussed in the detailed description, many other combinations of the disclosed features are also possible. Unless specifically limited, any feature or element of any embodiment may be used in combination with, or substituted for, any other feature or element of any other embodiment.

The present application includes and contemplates combinations with features and elements known to those of ordinary skills in the art. The disclosed embodiments, features, and elements of the present application may also be combined with any conventional features or elements to form a unique inventive solution as defined by the claims. Any feature or element of any embodiment may also be combined with feature(s) or element(s) from other inventive solution to form another unique inventive solution as defined by the claims. Accordingly, it should be understood that any of the features shown and/or discussed in the present application may be implemented alone or in any suitable combination. Thus, the embodiments are not subjected to limitations other than those made in accordance with the appended claims and their equivalent substitutions. In addition, various modifications and changes may be made within the protection scope of the appended claims.

Furthermore, when describing representative embodiments, the specification may have presented a method and/or process as a particular sequence of steps. However, to the extent that the method or process does not depend on a specific order of steps described by the present application, the method or process should not be limited to the specific order of steps described. As will be understood by those of ordinary skill in the art, other order of steps is also possible. Accordingly, a particular order of steps set forth in the specification should not be construed as limitations on the claims. Furthermore, the claims for the method and/or process should not be limited to the steps which are performed in the written order. Those skilled in the art can readily understand that these orders can be changed and still remain within the scope of the embodiments of the present application.

Embodiments of the present application provide a water outlet device and a water outlet system. The water outlet system may be installed in various occasions and environments, such as companies, schools, families, factories and the like to realize cleaning treatment of articles to be cleaned, so as to improve and enhance life quality and health of people. The water outlet device can be, but is not limited to, a faucet, a shower head or a spray gun. For the convenience of describing the technical solutions of the present application, the following takes the water outlet device being a shower head as an example for illustration.

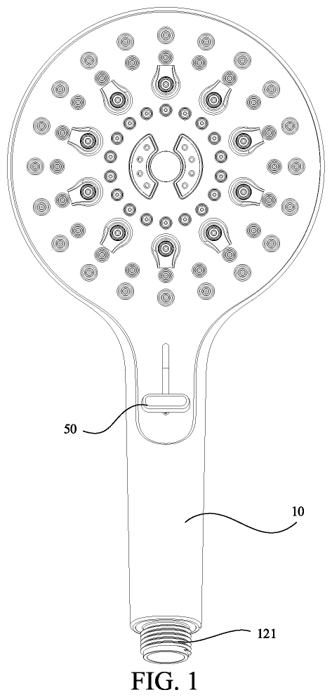

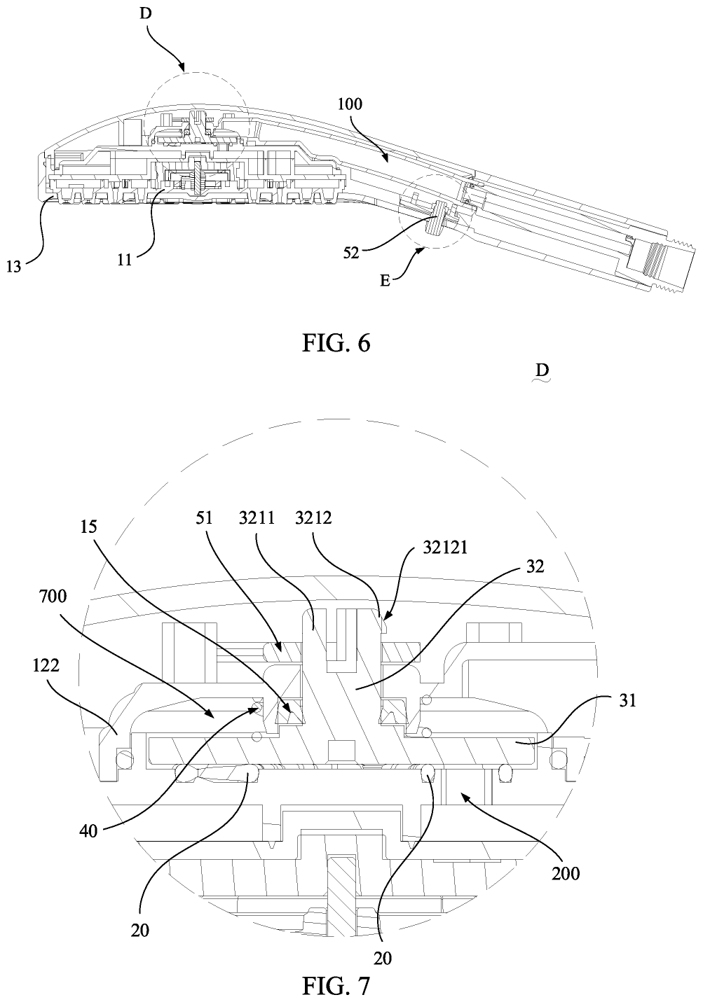

References are made to FIGS. 1-4, 6, 7 and 30 together to describe the water outlet system provided by embodiments of the present application. The water outlet system includes a water outlet device. The water outlet device includes a body mechanism 10, a first sealing member 20, a switching member 30, a supporting member 40 and a pushing mechanism 50. The body mechanism 10 is provided with a water separating end face 111 and a water outlet end face 112, and the water outlet end face 112 is provided with a plurality of water outlet areas 1121. Water can be discharged from different water outlet areas 1121 to realize different water outlet functions and form different water outlet effects, so as to meet different use requirements of users.

The body mechanism 10 is provided with a water inlet flow channel 100 and a plurality of water outlet flow channels 200. Each of the plurality of water outlet flow channels 200 is one-to-one corresponding to each of the plurality of water outlet areas 1121 and penetrates between the corresponding water outlet area 1121 and the water separating end face 111. That is, each water outlet area 1121 corresponds to a water outlet flow channel 200 capable of communicating with the water inlet flow channel 100 to guide water to the corresponding water outlet area 1121 and discharge the water.

The first sealing member 20 is provided on the water separating end face 111 and is provided with a plurality of flow holes 301. Each of the plurality of flow holes 301 is one-to-one corresponding to and communicates with each of the plurality of water outlet flow channels 200. The switching member 30 is movably installed on the body mechanism 10 and fitted against a side of the first sealing member 20 away from the water separating end face 111, and the switching member 30 is provided with a through hole 400. The supporting member 40 is supported between the body mechanism 10 and a side of the switching member 30 away from the first sealing member 20, and is movably connected with at least one of the body mechanism 10 and the switching member 30, so that the supporting member 40 may move with the switching member 30 synchronously (when the supporting member 40 is fixed to the switching member 30) or move relative to the switching member 30 (when the supporting member 40 is not fixed to the switching member 30) when the switching member 30 moves with respect to the body mechanism 10, so as to avoid interference with movement of the switching member 30 with respect to the body mechanism 10.

The pushing mechanism 50 is movably installed on the body mechanism 10. The pushing mechanism 50 is configured to be capable of driving the switching member 30 to move with respect to the body mechanism 10 so that the through hole 400 communicates one of the plurality of flow holes 301 with the water inlet flow channel 100, or the plurality of flow holes 301 disconnect from the water inlet flow channel 100.

The water outlet system further includes a water supply assembly. The body mechanism 10 is provided with a connecting member 121 connected to the water supply assembly. The connecting member 121 may be connected to the water supply assembly by, but not limited to, threaded connection, plug connection, snap connection or welding. The water supply assembly is configured to be capable of supplying water to the water inlet flow channel 100. The water supply assembly may be, but is not limited to, a manually controlled or an electrically controlled valve configuration, and the water inlet flow channel 100 is communicated with or disconnected from a water source by opening or closing the water supply assembly. The water includes, but is not limited to, clear water or pure water from a municipal water network.

To sum up, implementation of the embodiments of the present application will have the following beneficial effects: when the water outlet device of the above scheme is used and installed in a water outlet system, it not only makes the water outlet system have excellent cleaning efficiency, but also can ensure the sealing between the switching member 30 and the water outlet flow channels 200 and avoid occurrence of series leakage. Specifically, the water outlet device includes a body mechanism 10 provided with a water separating end face 111 and a water outlet end face 112, a first sealing member 20 provided on the water separating end face 111, a switching member 30 movably installed on the body mechanism 10 and fitted against a side of the first sealing member 20 away from the water separating end face 111, a supporting member 40 supported between the body mechanism 10 and a side of the switching member 30 away from the first sealing member 20, and a pushing mechanism 50 movably installed on the body mechanism 10. The water outlet end face 112 is provided with a plurality of water outlet areas 1121. A water outlet flow channel 200 penetrates between each water outlet area 1121 and the water separating end face 111. The pushing mechanism 50 drives the switching member 30 to move with respect to the body mechanism 10, so that a communication state between the water inlet flow channel 100 and the plurality of water outlet flow channels 200 can be changed, and then different water outlet areas 1121 may be switched to discharge water or the plurality of water outlet areas 1121 may be closed at the same time according to specific requirements in use. The provision of the supporting member 40 can ensure that the switching member 30 and the first sealing member 20 are closely fit, so that a change of water pressure has little influence on the sealing performance between the switching member 30 and the water outlet flow channels 200, thereby the occurrence of series leakage can be avoided when the water pressure is low.

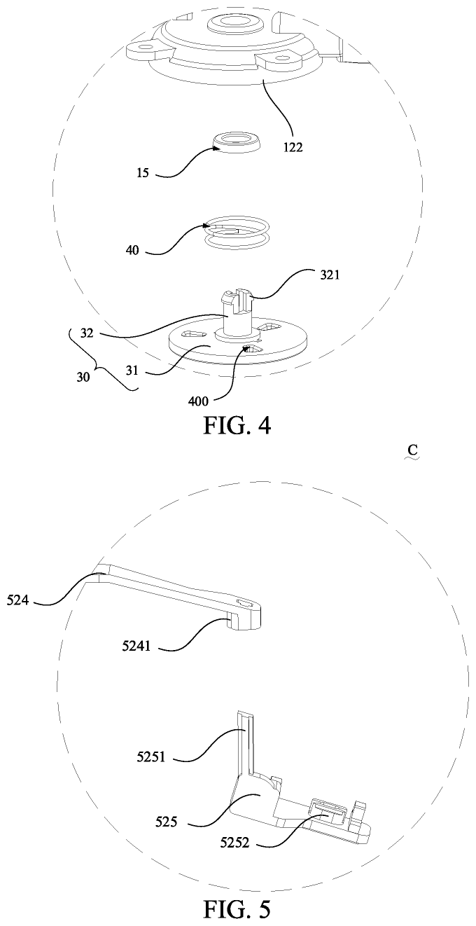

In an exemplary embodiment, referring to FIGS. 4 and 7 together, the supporting member 40 is elastically abutted against at least one of the body mechanism 10 and the switching member 30, so that the supporting member 40 can adapt to a change of a distance between the body mechanism 10 and the switching member 30 when the water pressure changes, adjust a supporting force according to the water pressure in real time, and feed back immediately when the water pressure changes instantaneously, so as to provide a corresponding supporting force and ensure the sealing between the switching member 30 and the water outlet flow channels 200.

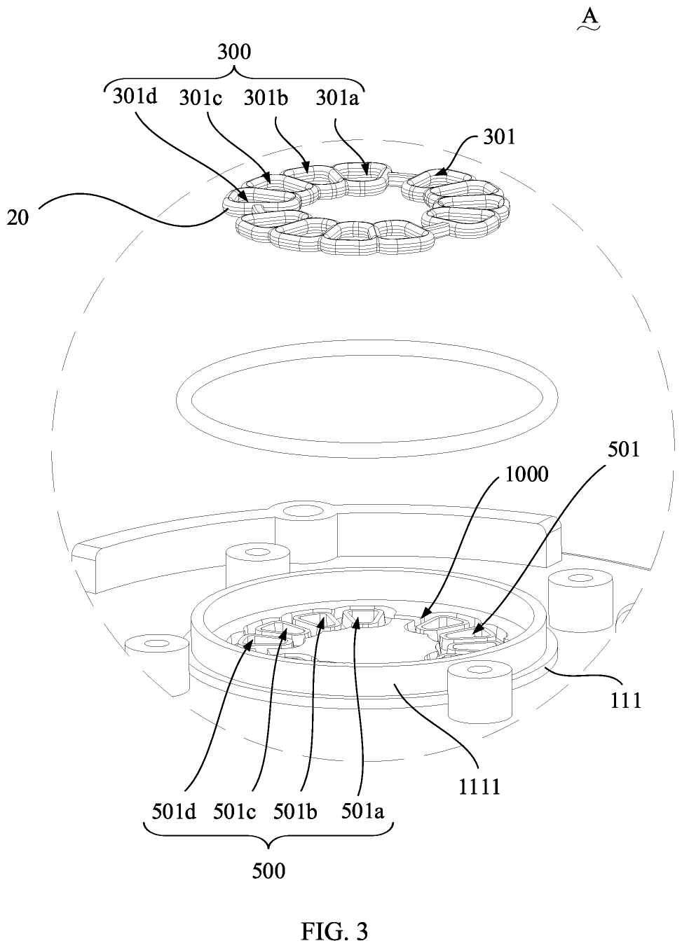

In an exemplary embodiment, referring to FIGS. 3, 4 and 7 together, movement of the switching member 30 with respect to the body mechanism 10 is rotation movement, and the supporting member 40 is a coil spring and is coaxially provided with a rotating axis of the switching member 30, so that a supporting force acting on the switching member 30 by the supporting member 40 can be evenly distributed on the switching member 30, a fitting state of the switching member 30 and the first sealing member 20 at each fitting position is ensured to be the same, and the first sealing member 20 can be evenly deformed, thereby ensuring a same sealing effect at all fitting positions. In an embodiment of the present application, the supporting member 40 is clamped between the body mechanism 10 and the switching member 30, and is movably connected with the body mechanism 10 and the switching member 30 respectively, so as not to hinder the rotation of the switching member 30 with respect to the body mechanism 10.

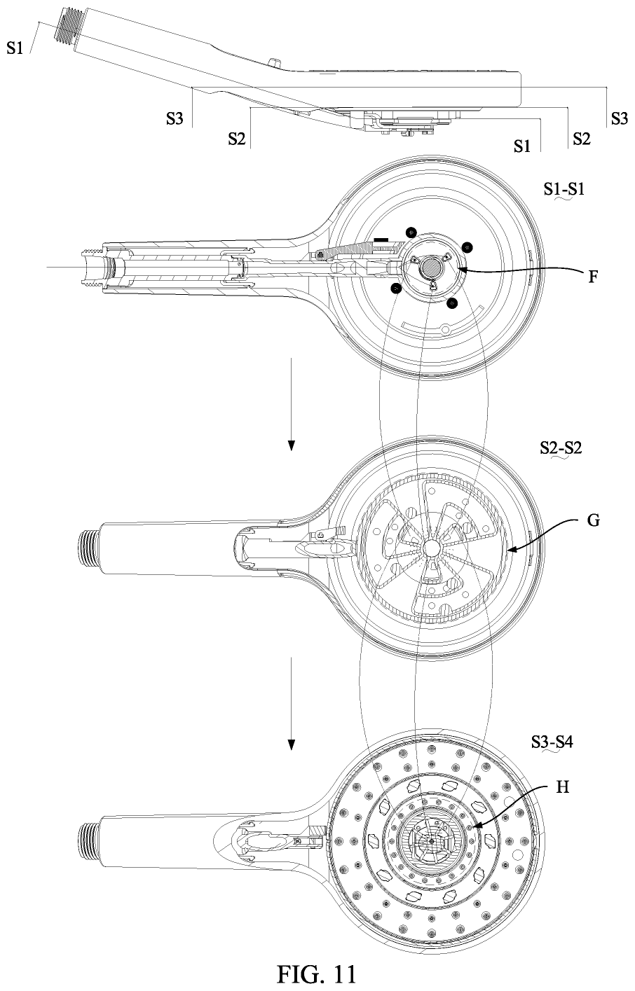

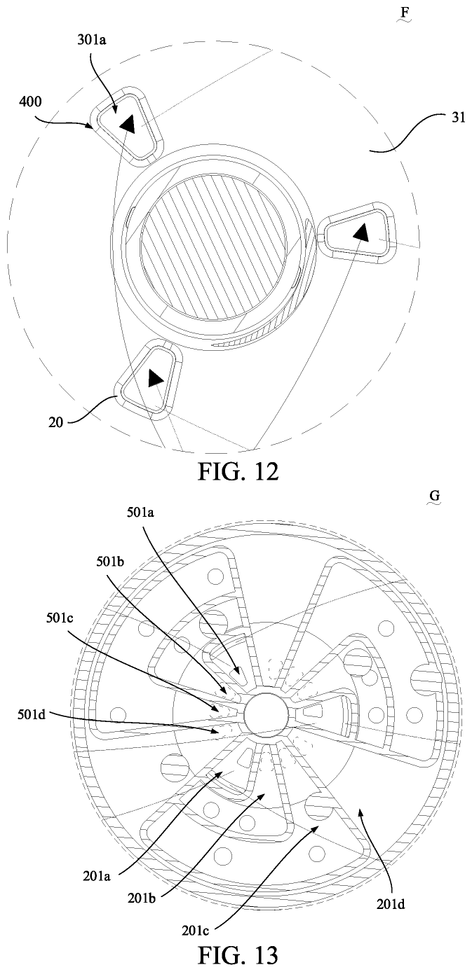

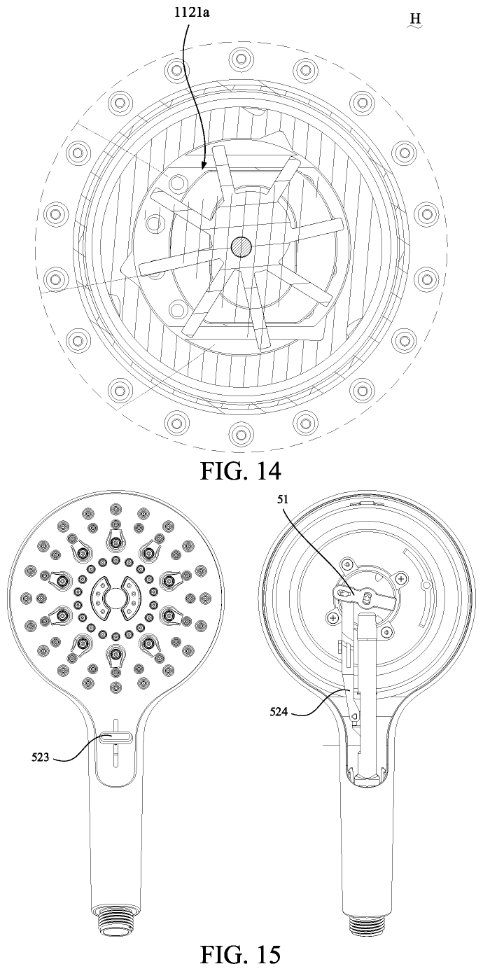

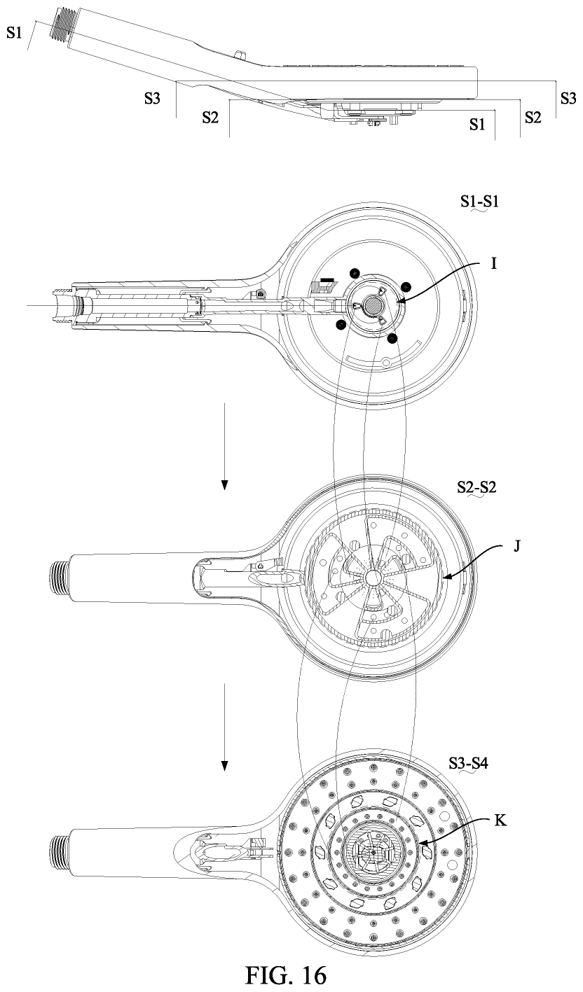

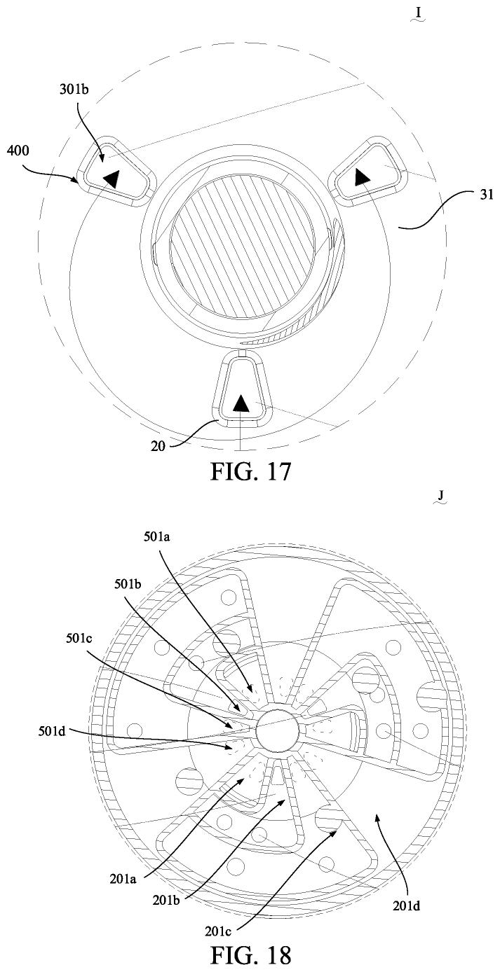

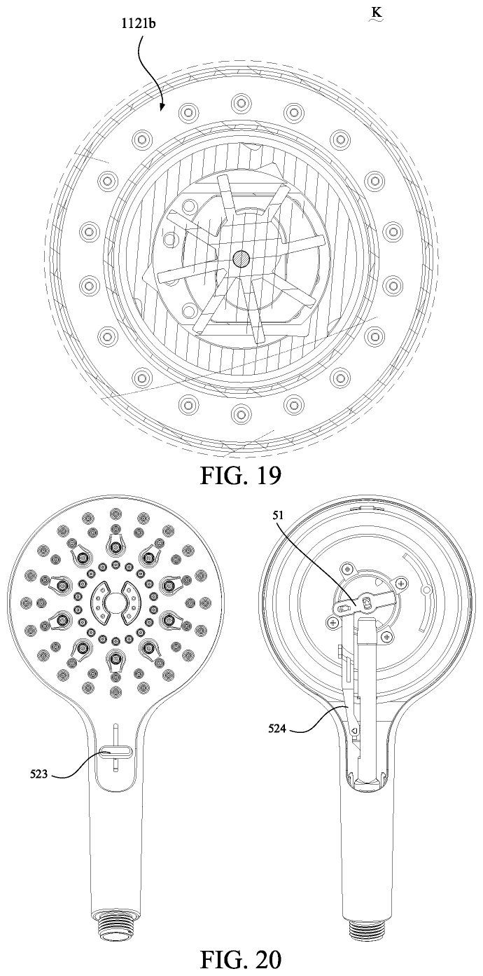

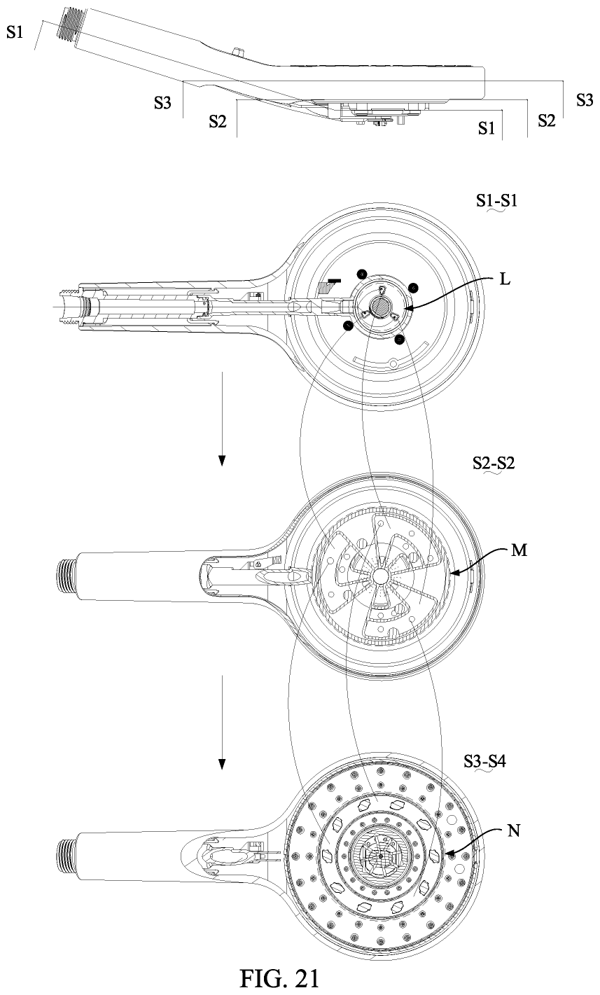

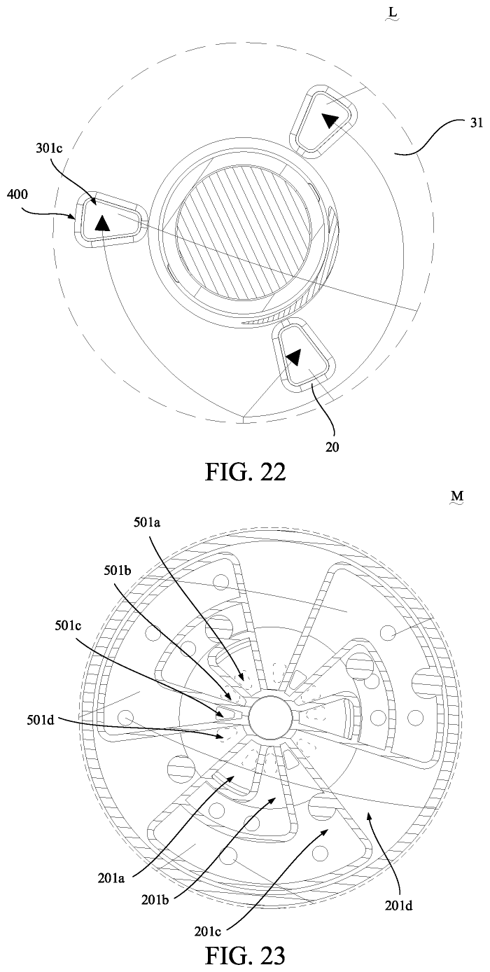

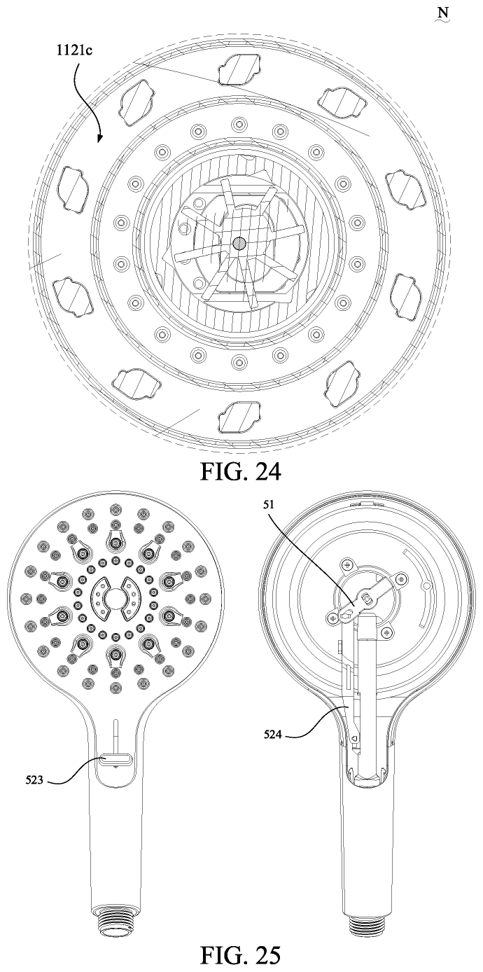

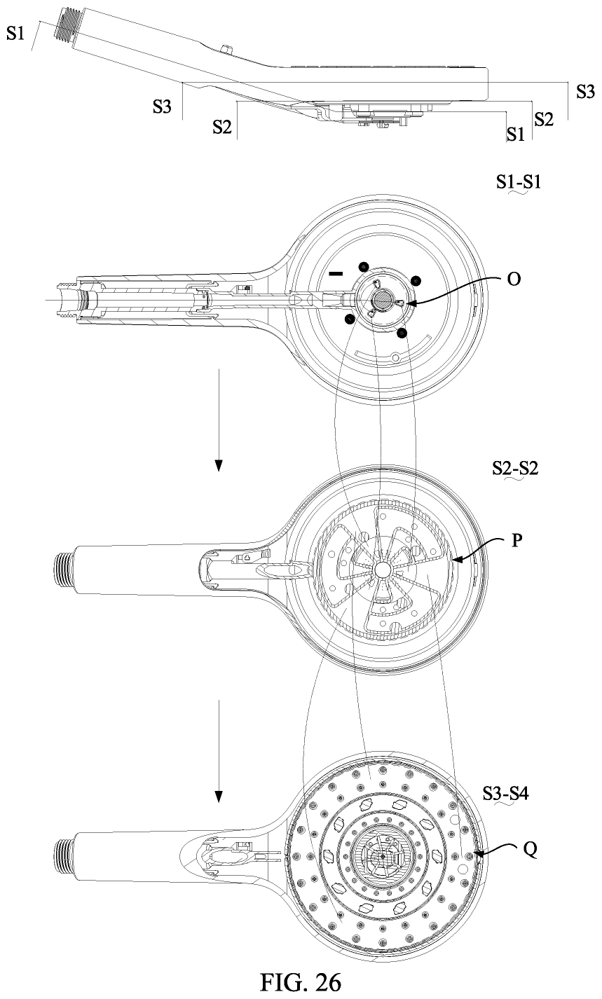

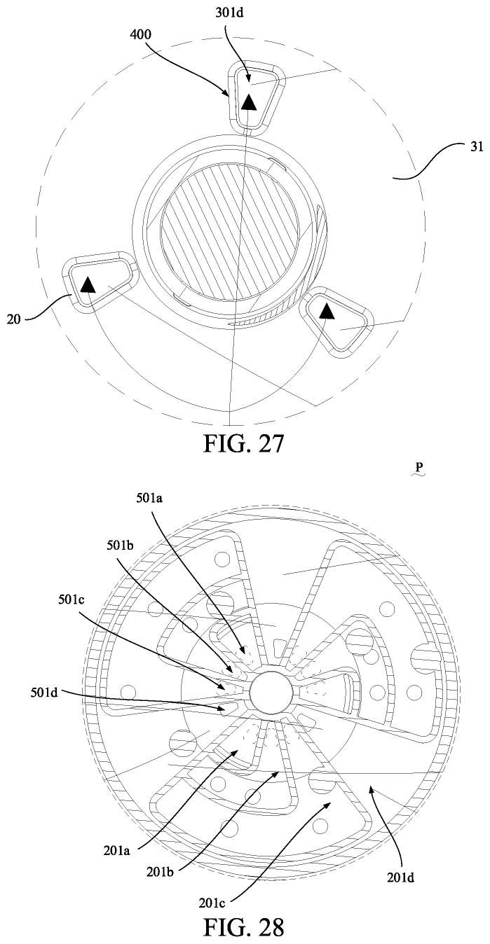

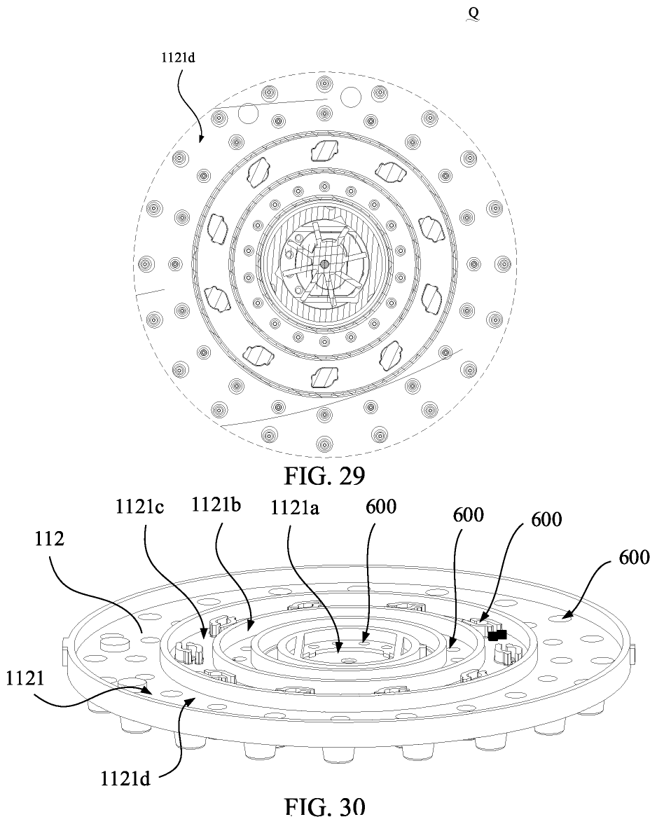

In an exemplary embodiment, referring to FIGS. 3, 4, and 10-29 together, each water outlet flow channel 200 is capable of forming a water inlet hole 501 on the water separating end face 111 and forming at least one water outlet hole 600 on the water outlet end face 112. The body mechanism 10 is provided with a plurality of flow channel groups, and each flow channel group includes a plurality of water outlet flow channels 200, and is capable of forming a water inlet hole group 500 on the water separating end face 111. Each water inlet hole group 500 includes a plurality of water inlet holes 501, that is, each flow channel group includes a plurality of water outlet flow channels 200 corresponding to a plurality of water outlet areas 1121.

The plurality of water inlet hole groups 500 are sequentially provided along a movement track of the switching member 30. The first sealing member 20 is provided with a plurality of flow hole groups 300, and each flow hole group 300 is one-to-one corresponding to each water inlet hole group 500. Each flow hole group 300 includes a plurality of flow holes 301. That is, each flow hole 301 communicates with one water inlet hole 501 of the corresponding water inlet hole group 500, and a plurality of through holes 400 are provided and are one-to-one corresponding to the plurality of flow hole groups 300, so that each through hole 400 can move with respect to the body mechanism with the switching member 30 to communicate one of the plurality of flow holes 301 of the corresponding flow hole group 300 with the water inlet flow channel 100. Each flow channel group includes a plurality of water outlet flow channels 200 corresponding to a plurality of water outlet areas 1121, and can form water outlet holes 600 corresponding to each water outlet area 1121. The plurality of water outlet holes 600 located in the same water outlet area 1121 are uniformly distributed in the water outlet area 1121, so that each water outlet area 1121 can uniformly discharge water.

In an embodiment of the present application, movement of the switching member 30 respect to the body mechanism 10 is rotation movement, so that the plurality of water inlet hole groups 500 are provided sequentially along a rotational track of the switching member 30, that is, the plurality of water inlet hole groups 500 are distributed around the rotating axis of the switching member 30.

Furthermore, in some embodiments, movement of the switching member 30 with respect to the body mechanism 10 is linear movement. In this case, the plurality of water inlet hole groups 500 are provided sequentially along a linear movement track of the switching member 30.

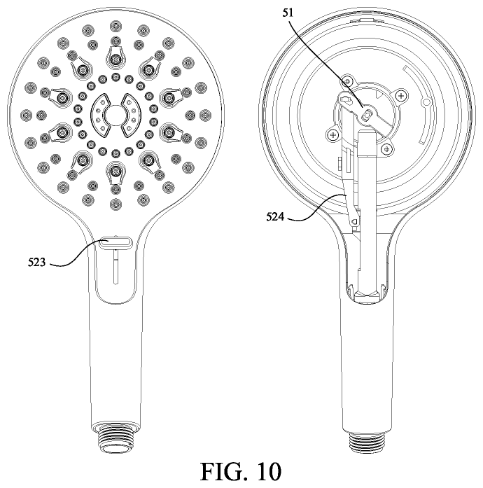

In an embodiment of the present application, referring to FIGS. 10 to 30 together, four groups of water outlet areas 1121 are provided, which respectively include a central area 1121a, an inner ring area 1121b, a middle ring area 1121c and an outer ring area 1121d provided sequentially along a radial direction of the water outlet end face 112. The central area 1121a is located at a center of the water outlet end face 112, the inner ring area 1121b is provided around an outer circumference of the central area 1121a, the middle ring area 1121c is provided around an outer circumference of the inner ring area 1121b, and the outer ring area 1121d is provided around an outer circumference of the middle ring area 1121c. The body mechanism 10 is provided with three flow channel groups, each of which includes four water outlet flow channels 200, and is capable of forming a water inlet hole group 500 on the water separating end face 111. Each of the water inlet hole groups 500 includes four water inlet holes 501, which are a first water inlet hole 501a, a second water inlet hole 501b, a third water inlet hole 501c, and a fourth water inlet hole 501d respectively.

Three water inlet hole groups 500 are provided sequentially along a movement track of the switching member 30. The first sealing member 20 is provided with three flow hole groups 300. Each of the water inlet hole groups 500 is one-to-one corresponding to each of the water inlet hole groups 500. Each flow hole group 300 includes four flow holes 301, which are a first flow hole 301a, a second flow hole 301b, a third flow hole 301c and a fourth flow hole 301d respectively. The first flow hole 301a communicates with the first water inlet hole 501a, the second flow hole 301b communicates with the second water inlet hole 501b, the third flow hole 301c communicates with the third water inlet hole 501c, and the fourth flow hole 301d communicates with the fourth water inlet hole 501d. Three through holes 400 are provided and are one-to-one corresponding to the plurality of flow hole groups 300. The switching member 30 is rotated with respect to the body mechanism 10, and the three through holes 400 can communicate three flow holes 301 corresponding to a same water outlet area 1121 in the three flow hole groups 300 with the water inlet flow channel 100, so that water is discharged from the water outlet area 1121.

In an embodiment of the present application, the four water outlet flow channels 200 in each flow channel group can also form four water outlet chambers on the body mechanism 10, which are a first water outlet chamber 201a, a second water outlet chamber 201b, a third water outlet chamber 201c, and a fourth water outlet chamber 201d respectively. The first water outlet chamber 201a communicates with the first water inlet hole 501a and communicates with the water outlet holes 600 provided in the central area 1121a. The second water outlet chamber 201b communicates with the second water inlet hole 501b and communicates with the water outlet holes 600 provided in the inner ring area 1121b. The third water outlet chamber 201c communicates with the third water inlet hole 501c and communicates with the water outlet holes 600 provided in the middle ring area 1121c. The fourth water outlet chamber 201d communicates with the fourth water inlet hole 501d and communicates with the water outlet holes 600 provided in the outer ring area 1121d.

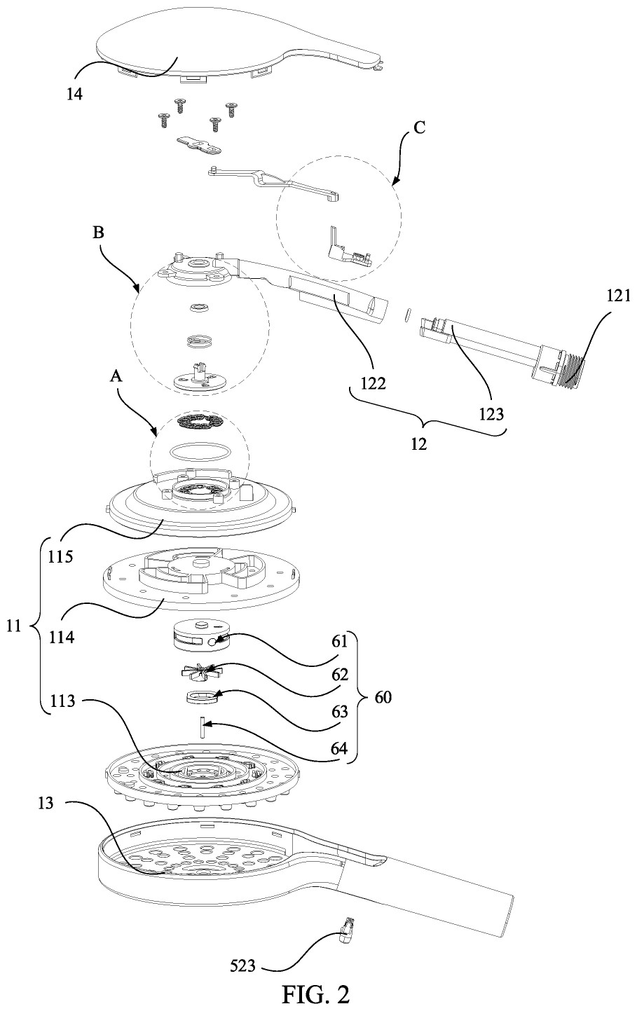

In an exemplary embodiment, referring to FIGS. 2, 4, 7 and 9 together, the body mechanism 10 includes a face shell assembly 11 and a water inlet assembly 12. The face shell assembly 11 is provided with the water separating end face 111 and the water outlet end face 112. The water inlet assembly 12 is connected with the water separating end face 111 and enclosed to form a water inlet chamber 700. The water inlet flow channel 100 is provided in the water inlet assembly 12 and communicates with the water inlet chamber 700.

The switching member 30 is installed in the water inlet chamber 700, so that an installation position of the switching member 30 is protected by the face shell assembly 11 and the water inlet assembly 12, thereby a stable working state of the switching member 30 can be ensured. The switching member 30 includes a switching portion 31 and a connecting portion 32, and the through holes 400 are provided on the switching portion 31. The switching portion 31 is fitted against the first sealing member 20. The connecting portion 32 is rotatably connected to the water inlet assembly 12. One end of the connecting portion 32 is connected with the switching portion 31, and the other end of the connecting portion 32 is protruded from a side of the water inlet assembly 12 facing away from the water inlet chamber 700 and is in transmission connection with the pushing mechanism 50, so that the pushing mechanism 50 can be avoided from entering the water inlet chamber 700 and being connected with the switching member 30, thereby reducing interference to inlet of the water, and provision of an avoidance structure and addition of a corresponding sealing structure on the face shell assembly 11 and/or the water inlet assembly 12 for satisfying movement of the pushing mechanism 50 can be avoided.

In an embodiment of the present application, the face shell assembly 11 includes a face cover 113, a water dispensing disk 114, and a water separating tray 115 which are stacked sequentially. The water outlet end face 112 is provided on the face cover 113. The water separating end face 111 is provided on the water separating tray 115. The water dispensing disk 114 and the water separating tray 115 are enclosed to form the first water outlet chamber 201a, the second water outlet chamber 201b, the third water outlet chamber 201c, and the fourth water outlet chamber 201d. In order to improve a water discharging effect of the water outlet device, the face shell assembly 11 may be further provided with a functional assembly. For example, in an embodiment of the present application, the face shell assembly 11 is provided with a pulse assembly 60 at a position corresponding to the central area 1121a so as to be able to form water discharging in pulses in the central area 1121a. The pulse assembly 60 includes a water ejecting ring 61, an impeller 62, a swing sheet 63, and a pin shaft 64. The water ejecting ring 61 is provided on the water dispensing disk 114 and is provided around the impeller 62. The impeller 62 is rotatably connected with the face cover 113 via the pin shaft 64. The swing sheet 63 is provided on the face cover 113. The swing sheet 63 is located between the water ejecting ring 61 and the impeller 62 and is provided around the impeller 62. The water outlet flow channel 200 where the water outlet holes 600 are located in the central area 1121a introduces water into the water ejecting ring 61, and the water ejecting ring 61 forms the water into a jet, which impacts the impeller 62 to rotate. The impeller 62 rotates to direct the water to the swing sheet 63, so that the swing sheet 63 swings with respect to the face cover 113, and the water swings and is discharged after passing through the swing sheet 63, to form water discharging in pulses.

The body mechanism 10 further includes a decoration shell 13 and a back cover 14. The face shell assembly 11 and the water inlet assembly 12 are installed in a space formed by the decoration shell 13 and the back cover 14. The water outlet end face 112 is fit to the decoration shell 13, and the decoration shell 13 is provided with a hollow-out portion where the water is discharged through the water outlet end face 112.

In an embodiment of the present application, the water inlet assembly 12 includes a water inlet member 122 and a connecting pipe 123, and the water inlet member 122 and the water separating end face 111 are enclosed to form the water inlet chamber 700. The connecting pipe 123 is connected with the water inlet member 122, and the water inlet flow channel 100 passes through the connecting pipe 123 and the water inlet member 122 sequentially to communicate with the water inlet chamber 700. The connecting member 121 is provided on the connecting pipe 123. The connecting portion 32 is rotatably connected with the water inlet member 122.

In an exemplary embodiment, referring to FIGS. 4 and 7 together, the body mechanism 10 further includes a second sealing member 15 sleeved on the connecting portion 32. The second sealing member 15 is configured to seal a gap between the connecting portion 32 and the water inlet assembly 12, so as to ensure sealing at a connecting position between the connecting portion 32 and the water inlet assembly 12 and prevent the water from discharging from the connecting position.

In an exemplary embodiment, referring to FIGS. 3 and 7 together, the water separating end face 111 is further provided with an annular wall 1111, the annular wall 1111 is provided around the water inlet chamber 700 and partially overlapped with the water inlet assembly 12, so that a connection area between the water separating end face 111 and the water inlet assembly 12 can be increased, and connection stability and sealing performance between the water separating end face 111 and the water inlet assembly 12 can be improved. In order to further improve the sealing performance between the water separating end face 111 and the water inlet assembly 12, a sealing structure may be further provided between the annular wall 1111 and the water inlet assembly 12. Furthermore, provision of the annular wall 1111 can further limit a position of the switching member 30 to ensure its positional stability, thereby ensuring stability of fitting between the switching member 30 and the first sealing member 20.

In an exemplary embodiment, referring to FIGS. 5, 6, 9-29 and 31 together, the pushing mechanism 50 includes a rotating member 51 and a pushing assembly 52. The rotating member 51 is fixedly connected to the connecting portion 32, and one of the rotating member 51 and the pushing assembly 52 is provided with a first transmission portion 511 and the other of the rotating member 51 and the pushing assembly 52 is provided with a second transmission portion 521. The first transmission portion 511 is provided with a chute 800, the second transmission portion 521 is at least partially accommodated in the chute 800 and capable of sliding and rotating with respect to the chute 800 so that the rotating member 51 is slidingly hinged with the pushing assembly 52. By the above configuration, a linear movement of the pushing assembly 52 can be changed into the rotation movement of the switching member 30 which facilitates driving the switching member 30. Moreover, the provision of the first transmission portion 511 and the second transmission portion 521 makes the sliding hinge structure of the pushing assembly 52 and the rotating member 51 relatively simple, which is convenient for production and manufacture, and saves cost.

In an embodiment of the present application, the rotating member 51 is provided with a first transmission portion 511. The pushing assembly 52 is provided with a second transmission portion 521. The chute 800 penetrates through the first transmission portion 511 in a moving direction perpendicular to the second transmission portion 521. The second transmission portion 521 has a columnar shape and is provided through the chute 800, so that connection stability between the first transmission portion 511 and the second transmission portion 521 can be improved, thereby improving the transmission stability.

In an exemplary embodiment, referring to FIGS. 4, 7, 9 and 33 together, the connecting portion 32 is provided with a first clamping member 321, and the rotating member 51 is provided with a clamping slot 900. The first clamping member 321 is clamped with the rotating member 51 through the clamping slot 900 and is in anti-rotation cooperation with the rotating member 51, so that the connecting portion 32 and the rotating member 51 can be assembled quickly and synchronization of rotation can be ensured.

In an embodiment of the present application, the first clamping member 321 includes a plurality of elastic arms 3211. A limiting structure 3212 is protruded from each elastic arm 3211. The plurality of elastic arms 3211 can be in abutting cooperation with the rotating member 51 through the plurality of limiting structures 3212 to gather and pass through the clamping slot 900 so as to facilitate a rapid insertion of the elastic arms 3211 into the clamping slot 900. The plurality of elastic arms 3211 can be reset after the plurality of limiting structures 3212 pass through the clamping slot 900. In this case, the elastic arms 3211 can be reset without being restricted by a driving force generated by abutting the limiting structures 3212 against the rotating member 51, and the plurality of limiting structures 3212 can be in position-limiting cooperation with the rotating member 51, so as to restrict the first clamping member 321 from disengaging from the clamping slot 900 and improve connection stability between the rotating member 51 and the switching member 30.

The limiting structure 3212 is provided with a guide surface 32121 to facilitate sliding of the limiting structure 3212 into the clamping slot 900, thereby facilitating gathering of the plurality of elastic arms 3211 and further facilitating rapid assembly of the rotating member 51 and the switching member 30.

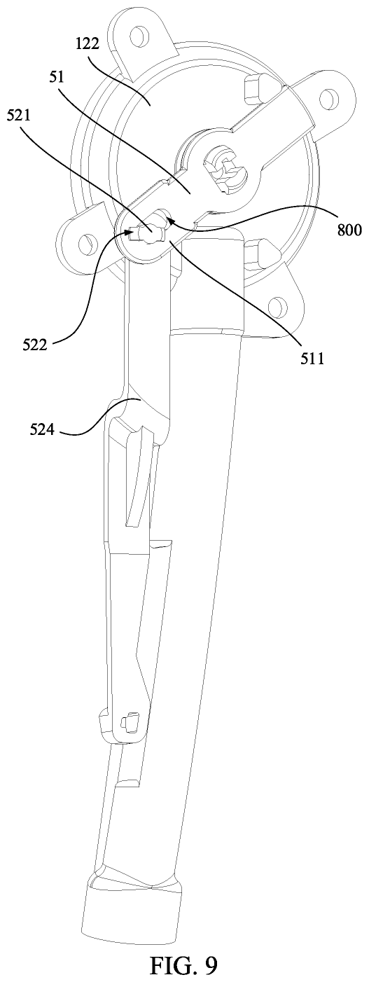

In an exemplary embodiment, as shown in FIG. 9, a limiting portion 522 is provided on the second transmission portion 521. During the sliding and rotation of the second transmission portion 521 with respect to the chute 800, an orthographic projection of the limiting portion 522 on the first transmission portion 511 along an axial direction of the second transmission portion 521 can be located in the chute 800 so as to facilitate separation of the first transmission portion 511 from the second transmission portion 521, or partially located on the first transmission portion 511 so as to prevent separation of the first transmission portion 511 from the second transmission portion 521. Thus, the limiting portion 522 may not only be connected with or separated from the first transmission portion 511 along with the second transmission portion 521, but also realize position-limiting cooperation with the first transmission portion 511. The limiting portion 522 and the second transmission portion 521 are integrally provided, thus saving the number of components. During the use of the water outlet device, a rotation range of the rotating member 51 is configured such that the orthographic projection of the limiting portion 522 on the first transmission portion 511 along the axial direction of the second transmission portion 521 is not located in the chute 800. In an embodiment of the present application, the second transmission portion 521 and the limiting portion 522 have a T-shaped structure as a whole, and a top cross beam of the T-shaped structure can be connected with or separated from the first transmission portion 511 by passing through the chute 800. At this time, the orthographic projection of the limiting portion 522 on the first transmission portion 511 along the axial direction of the second transmission portion 521 is located in the chute 800. During the use of the water outlet device, the top cross beam of the T-shaped structure partially overlaps the first transmission portion 511 as the second transmission portion 521 slides and rotates with respect to the chute 800, so as to be in position-limiting cooperation with the first transmission portion 511. At this time, the orthographic projection of the limiting portion 522 on the first transmission portion 511 along the axial direction of the second transmission portion 521 is partially located on the first transmission portion 511. It may be understood that in other embodiments, the limiting portion 522 may also form other structural forms with the second transmission 521, as long as the other structural forms can be separated from the first transmission portion 511 when the second transmission portion 521 slides and rotates with respect to the chute 800 to a certain angle, and can be connected with the first transmission portion 511 through the chute 800 at this angle, and can be in position-limiting cooperation with the first transmission portion 511 when the second transmission portion 521 slides and rotates with respect to the chute 800 to other angles.

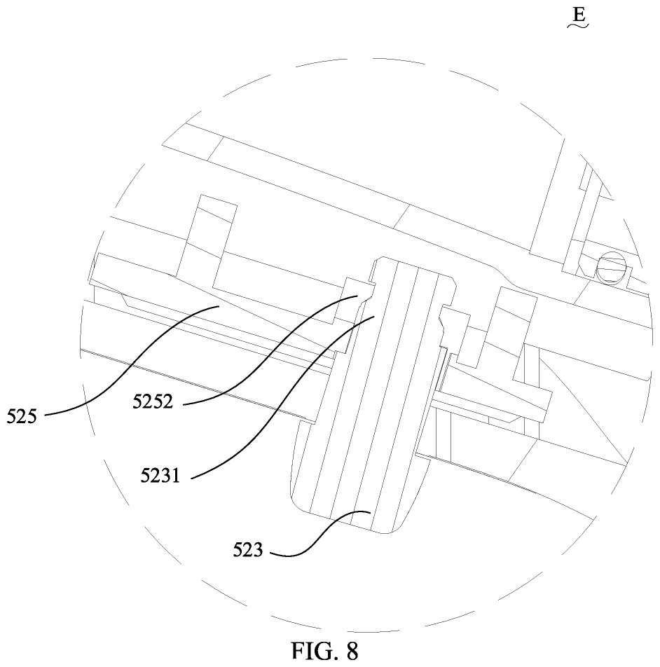

In an exemplary embodiment, referring to FIGS. 5 and 8-29 together, the pushing assembly 52 includes a push button 523 and a push rod 524. The push button 523 is exposed from the body mechanism 10 to facilitate driving by a finger. The push rod 524 is connected with the push button 523, and the first transmission portion 511 or the second transmission portion 521 is provided on the push rod 524. Thus, the push rod 524 can transmit a driving force acting on the push button 523 to an inside of the water outlet device, which can further optimize an installing position of the push button 523 on the body mechanism 10 and a sliding hinge position of the pushing assembly 52 and the rotating member 51 while ensuring the effective transmission of the driving force, so that it is more convenient and labor-saving for finger to drive the rotating member 51 to rotate with respect to the body mechanism 10 through the pushing assembly 52. In an embodiment of the present application, the second transmission portion 521 is provided on the push rod 524.

At least one of the push rod 524 and the push button 523 is in sliding connection with the body mechanism 10 to improve sliding stability of the pushing assembly 52 with respect to the body mechanism 10.

In an exemplary embodiment, referring to FIGS. 5 and 8-29 together, the pushing assembly 52 further includes a transmission member 525. The transmission member 525 is in transmission connection between the push button 523 and the push rod 524 to further optimize the installing position of the push button 523 on the body mechanism 10 and the sliding hinge position of the pushing assembly 52 and the rotating member 51. In addition, the rotating member 51, the push rod 524, the transmission member 525 and the push button 523 may be detachably connected with each other, which facilitates changing types of the rotating member 51, the push rod 524, the transmission member 525 and the push button 523 to adapt to different types of water outlet devices.

In an exemplary embodiment, referring to FIGS. 5 and 8-29 together, the push rod 524 is provided with a first plug portion 5241, and the transmission member 525 is provided with a second plug portion 5251. The first plug portion 5241 and the second plug portion 5251 are in plug-in cooperation, so that the push rod 524 and the transmission member 525 are in anti-rotation cooperation. This configuration can facilitate rapid assembly between the push rod 524 and the transmission member 525, avoid rotation between the push rod 524 and the transmission member 525, and ensure stable transmission of the driving force; and/or

the push button 523 is provided with a third plug portion 5231, and the transmission member 525 is provided with a fourth plug portion 5252. The third plug portion 5231 and the fourth plug portion 5252 are in plug-in cooperation, so that the push button 523 and the transmission member 525 are in anti-rotation cooperation. This configuration can facilitate rapid assembly between the push button 523 and the transmission member 525, avoid rotation between the push button 523 and the transmission member 525, and ensure stable transmission of the driving force.

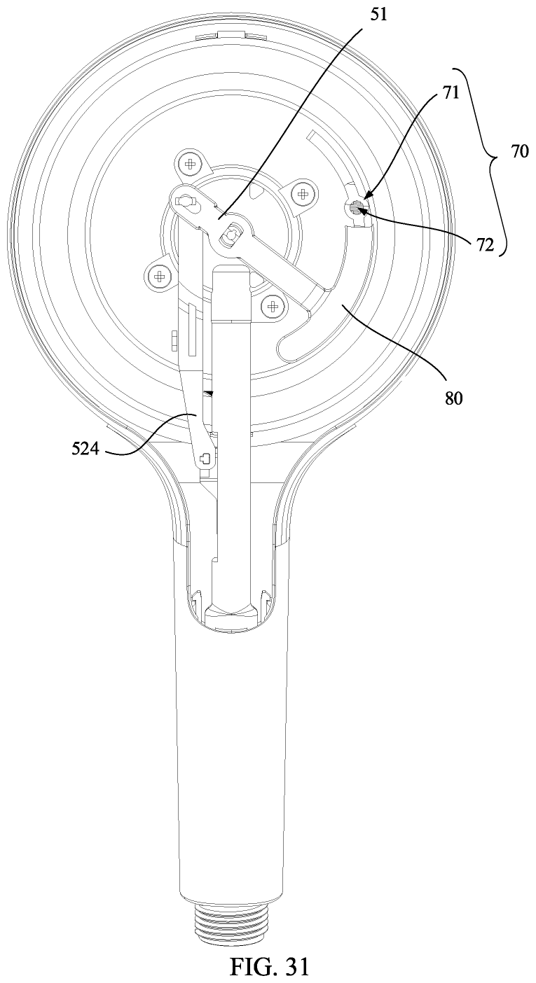

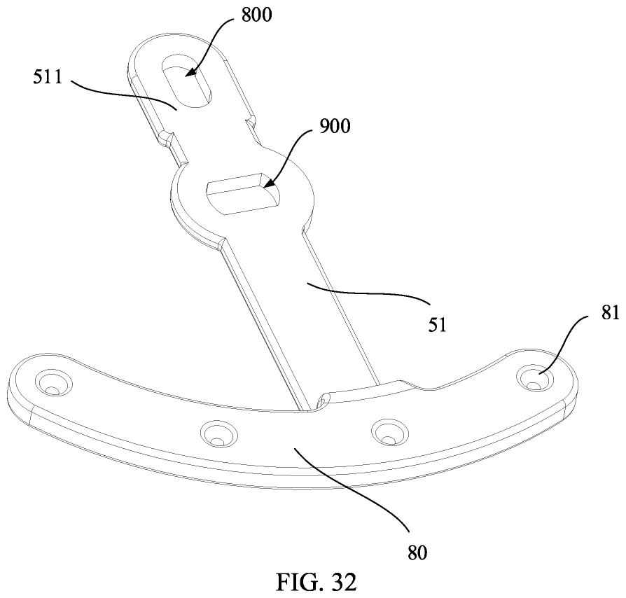

In an exemplary embodiment, referring to FIGS. 31 and 32 together, the water outlet device further includes a positioning assembly 70 provided on one of the water separating end face 111 and the rotating member 51, a positioning member 80 is provided on the other of the water separating end face 111 and the rotating member 51. The positioning member 80 is provided with a plurality of positioning portions 81 configured to cooperate with the positioning assembly 70 for positioning under different communication or disconnection states between the water inlet flow channel 100 and the plurality of water outlet flow channels 200 respectively, so as to be able to sense whether the rotating member 51 rotates to a preset position, thereby sensing the communication or disconnection state of the water inlet flow channel 100 and the plurality of water outlet flow channels 200 corresponding to each preset position, and further sensing whether a water path is switched in place. In an embodiment of the present application, the positioning portion 81 has a groove structure.

In an exemplary embodiment, referring to FIGS. 31 and 32 together, the positioning assembly 70 includes an installing member 71 and an elastic member 72. The installing member 71 is provided on one of the water separating end face 111 and the rotating member 51, the installing member 71 is provided with an installing space, and the elastic member 72 is installed in the installing space and capable of abutting against the positioning member 80. Thus, the elastic member 72 can facilitate better fitting with the positioning member 80, thereby avoiding a gap between the positioning assembly 70 and the positioning member 80, so that the elastic member 72 can cooperate with the positioning portion 81 more accurately, and a position sensing accuracy can be improved. The elastic member 72 may be made of an elastomeric material.

In an exemplary embodiment, referring to FIGS. 31 and 32 together, the installing member 71 is provided on the water separating end face 111, the positioning member 80 is provided on the rotating member 51, and the water separating end face 111 is further provided with a support structure 1112 supported between the water separating end face 111 and the positioning member 80. Thus, the support structure 1112 can cooperate with the water separating end face 111 to support the positioning member 80, and further support the rotating member 51, so as to ensure rotation stability of the rotating member 51.

The support structure 1112 is connected with the installing member 71 so as to improve structural stability of the installing member 71 and the support structure 1112, and ensure stability of the cooperation between the positioning assembly 70 and the positioning member 80 and the rotation stability of the rotating member 51.

In an exemplary embodiment, referring to FIGS. 3 and 7 together, the water separating end face 111 is provided with an installation slot 1000, and the first sealing member 20 can fill the installation slot 1000 and partially protrude from the installation slot 1000, so that the connection stability between the first sealing member 20 and the water separating end face 111 can be improved by providing the installation slot 1000, and a risk of driving the first sealing member 20 to move with respect to the water separating end face 111 during the movement of the switching member 30 can be reduced.

In the description of the present application, it should be noted that the orientation or position relationships indicated by the terms “upper”, “lower”, “one side”, “the other side”, “one end”, “the other end”, “side”, “relative”, “corners”, “periphery” and “square structure” or the like are based on the orientation or position relationships shown in the drawings, which are only for convenience of describing the present application and simplifying the description, rather than indicating or implying that the structure referred has the specific orientation, or is constructed and operated in the specific orientation, and thus cannot be interpreted as a limitation on the present application.

In the description of the embodiments of the present application, unless otherwise explicitly specified and limited, the terms “connection”, “direct connection”, “indirect connection”, “fixed connection”, “installation” and “assembly” should be understood in a broad sense. For those of ordinary skills in the art, the specific meanings of the aforementioned terms in the present application may be understood according to specific situation.

Although implementations disclosed in the present application are described above, the described contents are only implementations adopted for facilitating understanding of the present application, and are not intended to limit the present application. It should be noted that the above embodiments or implementations are exemplary only and not limiting. Therefore, the present disclosure is not limited to what is specifically shown and described herein. Various modifications, substitutions or omissions may be made to the form and details of implementation without departing from the scope of the present disclosure.

What is claimed is:

1. A water outlet device, comprising:
a body mechanism provided with a water separating end face and a water outlet end face, the water outlet end face being provided with a plurality of water outlet areas, wherein the body mechanism is provided with a water inlet flow channel and a plurality of water outlet flow channels, and each of the plurality of water outlet flow channels is one-to-one corresponding to each of the plurality of water outlet areas and penetrates between the corresponding water outlet area and the water separating end face;
a first sealing member provided on the water separating end face and provided with a plurality of flow holes, each of the plurality of flow holes being one-to-one corresponding to and communicating with each of the plurality of water outlet flow channels;
a switching member movably installed on the body mechanism and fitted against a side of the first sealing member away from the water separating end face, wherein the switching member is provided with a through hole;
a supporting member supported between the body mechanism and a side of the switching member away from the first sealing member and movably connected with at least one of the body mechanism and the switching member; and
a pushing mechanism movably installed on the body mechanism, wherein the pushing mechanism is configured to be capable of driving the switching member to move with respect to the body mechanism so that the through hole communicates one of the plurality of flow holes with the water inlet flow channel, or the plurality of flow holes disconnect from the water inlet flow channel.

2. The water outlet device according to claim 1, wherein the supporting member is elastically abutted against at least one of the body mechanism and the switching member.

3. The water outlet device according to claim 2, wherein the switching member moves in a rotating manner with respect to the body mechanism, and the supporting member is a coil spring and is coaxially provided with a rotating axis of the switching member.

4. The water outlet device according to claim 3, wherein the body mechanism comprises a face shell assembly and a water inlet assembly, wherein the face shell assembly is provided with the water separating end face and the water outlet end face, the water inlet assembly and the water separating end face are connected and enclosed to form a water inlet chamber, the water inlet flow channel is provided in the water inlet assembly and communicates with the water inlet chamber; and
the switching member is installed in the water inlet chamber and comprises a switching portion and a connecting portion, the through hole is provided on the switching portion, the switching portion is fitted against the first sealing member, the connecting portion is rotatably connected with the water inlet assembly, one end of the connecting portion is connected with the switching portion, and the other end of the connecting portion is protruded from a side of the water inlet assembly facing away from the water inlet chamber and is in transmission connection with the pushing mechanism.

5. The water outlet device according to claim 4, wherein the body mechanism further comprises a second sealing member sleeved on the connecting portion, and the second sealing member is configured to seal a gap between the connecting portion and the water inlet assembly; and/or
the water separating end face is further provided with an annular wall, the annular wall is provided around the water inlet chamber and partially overlapped with the water inlet assembly.

6. The water outlet device according to claim 4, wherein the pushing mechanism comprises a rotating member and a pushing assembly, the rotating member is fixedly connected with the connecting portion, one of the rotating member and the pushing assembly is provided with a first transmission portion, the other of the rotating member and the pushing assembly is provided with a second transmission portion, the first transmission portion is provided with a chute, and the second transmission portion is at least partially accommodated in the chute, and is capable of sliding and rotating with respect to the chute, so that the rotating member is slidingly hinged with the pushing assembly.

7. The water outlet device according to claim 6, wherein the connecting portion is provided with a first clamping member, the rotating member is provided with a clamping slot, and the first clamping member is clamped with the rotating member through the clamping slot and is in anti-rotation cooperation with the rotating member; and/or
a limiting portion is provided on the second transmission portion, and during sliding and rotation of the second transmission portion with respect to the chute, an orthographic projection of the limiting portion on the first transmission portion along an axial direction of the second transmission portion is capable of being located in the chute so as to facilitate separation of the first transmission portion from the second transmission portion, or partially located on the first transmission portion so as to prevent separation of the first transmission portion from the second transmission portion.

8. The water outlet device according to claim 6, wherein the pushing assembly comprises a push button and a push rod, the push button is exposed on the body mechanism, the push rod is connected with the push button, and at least one of the push rod and the push button is in sliding connection with the body mechanism; and
the first transmission portion or the second transmission portion is provided on the push rod.

9. The water outlet device according to claim 8, wherein the pushing assembly further comprises a transmission member which is in transmission connection between the push button and the push rod.

10. The water outlet device according to claim 9, wherein the push rod is provided with a first plug portion, the transmission member is provided with a second plug portion, the first plug portion and the second plug portion are in plug-in cooperation, so that the push rod and the transmission member are in anti-rotation cooperation; and/or
the push button is provided with a third plug portion, the transmission member is provided with a fourth plug portion, the third plug portion and the fourth plug portion are in plug-in cooperation, so that the push button and the transmission member are in anti-rotation cooperation.

11. The water outlet device according to claim 6, wherein the water outlet device further comprises a positioning assembly provided on one of the water separating end face and the rotating member, a positioning member is provided on the other of the water separating end face and the rotating member, and a plurality of positioning portions are provided on the positioning member, and the plurality of positioning portions are configured to cooperate with the positioning assembly for positioning under different communication or disconnection states between the water inlet flow channel and the plurality of water outlet flow channels, respectively.

12. The water outlet device according to claim 11, wherein the positioning assembly comprises an installing member and an elastic member, the installing member is provided on one of the water separating end face and the rotating member, the installing member is provided with an installing space, and the elastic member is installed in the installing space and is capable of being abutted against the positioning member.

13. The water outlet device according to claim 12, wherein the installing member is provided on the water separating end face, the positioning member is provided on the rotating member, and the water separating end face is further provided with a support structure supported between the water separating end face and the positioning member.

14. The water outlet device according to claim 1, wherein the water separating end face is provided with an installing slot, and the first sealing member is capable of filling the installing slot and partially protrudes from the installing slot; and/or
each of the plurality of water outlet flow channels is capable of forming a water inlet hole on the water separating end face and forming at least one water outlet hole on the water outlet end face, the body mechanism is provided with a plurality of flow channel groups, each of the plurality of flow channel groups comprises the plurality of water outlet flow channels, and water inlet hole groups are capable of being formed on the water separating end face, and each water inlet hole group comprises a plurality of water inlet holes;
the plurality of water inlet hole groups are provided sequentially along a movement track of the switching member, the first sealing member is provided with a plurality of flow hole groups, each of the plurality of flow hole groups is one-to-one corresponding to each of the water inlet hole groups, each of the flow hole groups comprises the plurality of flow holes, a plurality of through holes are provided and are one-to-one corresponding to the plurality of flow hole groups; and
a plurality of water outlet holes located in a same water outlet area are uniformly distributed in the water outlet area.

15. A water outlet system comprising:
the water outlet device according to claim 1.

16. The water outlet device according to claim 7, wherein the water outlet device further comprises a positioning assembly provided on one of the water separating end face and the rotating member, a positioning member is provided on the other of the water separating end face and the rotating member, and a plurality of positioning portions are provided on the positioning member, and the plurality of positioning portions are configured to cooperate with the positioning assembly for positioning under different communication or disconnection states between the water inlet flow channel and the plurality of water outlet flow channels, respectively.

17. The water outlet device according to claim 8, wherein the water outlet device further comprises a positioning assembly provided on one of the water separating end face and the rotating member, a positioning member is provided on the other of the water separating end face and the rotating member, and a plurality of positioning portions are provided on the positioning member, and the plurality of positioning portions are configured to cooperate with the positioning assembly for positioning under different communication or disconnection states between the water inlet flow channel and the plurality of water outlet flow channels, respectively.

18. The water outlet device according to claim 9, wherein the water outlet device further comprises a positioning assembly provided on one of the water separating end face and the rotating member, a positioning member is provided on the other of the water separating end face and the rotating member, and a plurality of positioning portions are provided on the positioning member, and the plurality of positioning portions are configured to cooperate with the positioning assembly for positioning under different communication or disconnection states between the water inlet flow channel and the plurality of water outlet flow channels, respectively.

19. The water outlet device according to claim 10, wherein the water outlet device further comprises a positioning assembly provided on one of the water separating end face and the rotating member, a positioning member is provided on the other of the water separating end face and the rotating member, and a plurality of positioning portions are provided on the positioning member, and the plurality of positioning portions are configured to cooperate with the positioning assembly for positioning under different communication or disconnection states between the water inlet flow channel and the plurality of water outlet flow channels, respectively.
